(19) United States
(12) Patent Application Publication
(10) Pub. No.: US 2011/0117797 A1
(43) Pub. Date: May 19, 2011

(54) Conducting bracket that can be bridged for expansion of multi-facet lighting chips

(76) Inventor: Han-Ming Lee, Hsin Chu City (TW)

(21) Appl. No.: 12/590,699

(22) Filed: Nov. 13, 2009

(51) Int. Cl. H01R 13/02

(52) U.S. Cl. 439/890

(57) ABSTRACT

The present invention relates to a conducting bracket that can be bridged for expansion of multi-facet lighting chips, comprising a plurality of conducting brackets, a plurality of chips, a plurality of conducting wires, a plurality of fluorescent layers and sealing blocks, the main improvements including: a third conducting bracket is provided in addition to the 2 traditional conducting brackets, the 3^{rd} conducting bracket enables serial connection and bridging of lighting chips of different blocks for expansion of 2-facet, 3-facet, 4-facet (and above) serial connection and lighting function of chips of different blocks, wherein the surface of the chips of the blocks is covered with the fluorescent layer by design to allow the chips to provide the choices of color system effects of different light sources and achieve the industrial application of a single LED bridged for expansion of multi-facet lighting sources.

### BACKGROUND OF THE INVENTION

The ordinary single LED lamp is widely used in various electronic products. Its composition structure is shown in FIG. 6. The chips in the chip cup above the conducting pin generate the light source effect of forward refraction and focusing and are limited to the single chip focusing function in actual applications without the light source effect of multi-facet lighting, making it necessary to improve and perfect the structure of this LED lamp to be diversified and practical.

### SUMMARY OF THE INVENTION

The primary purpose of the present invention is to provide a conducting bracket that can be bridged for expansion of multi-facet lighting chips and in particular one comprising a plurality of conducting brackets, a plurality of chips, a plurality of conducting wires, a plurality of fluorescent layers and sealing blocks to achieve the purpose of a single LED being bridged for expansion of multi-facet light sources.

The secondary purpose of the present invention is to provide a conducting bracket that can be bridged for expansion of multi-facet lighting chips and in particular one wherein a 3^{rd} conducting bracket is provided in addition to the two traditional conducting brackets for serial connection and bridging of the lighting chips of different blocks.

Another purpose of the present invention is to provide a conducting bracket that can be bridged for expansion of multi-facet lighting chips and in particular to one wherein the third conducting bracket design is adopted to realize the function of serial connection and uniform lighting of the chips of the multi-facet blocks.

Another purpose of the present invention is to provide a conducting bracket that can be bridged for expansion of multi-facet lighting chips and in particular to one wherein the surface of the chips of different blocks is covered with a fluorescent layer to allow the chips to provide the choice of color system effects of different light sources.

### BRIEF DESCRIPTION OF THE DRAWINGS

FIG. 1 is a 3D diagram of the present invention.

FIG. 2 is a schematic diagram of the components of the present invention.

FIG. 3 is inner schematic of the rectangle block of the present invention bridged and sealed in the sealing block.

FIG. 4 is a cross-section 3D diagram of the present invention.

FIG. 5 is a 3D schematic of the lighting chip of the present invention.

FIG. 6 is a schematic of the traditional structure.

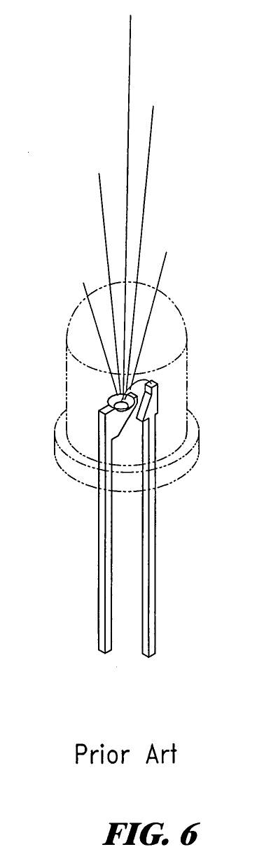

FIG. 7 is a decomposition schematic of the assemblies of another embodiment of the 3^{rd} conducting bracket of the present invention.

FIG. 8 is a function diagram of another embodiment of the 3^{rd} conducting bracket of the present invention.

FIG. 9 is a decomposition schematic of the assemblies of another embodiment of the 3^{rd} conducting bracket of the present invention.

FIG. 10 is a function diagram of another embodiment of the 3^{rd} conducting bracket of the present invention.

FIG. 11 is a decomposition schematic of the assemblies of another embodiment of the 3^{rd} conducting bracket of the present invention.

FIG. 12 is a function diagram of another embodiment of the 3^{rd} conducting bracket of the present invention.

FIG. 13 is a decomposition schematic of the assemblies of another embodiment of the 3^{rd} conducting bracket of the present invention.

FIG. 14 is a function diagram of another embodiment of the 3^{rd} conducting bracket of the present invention.

FIG. 15 is a decomposition schematic of the assemblies of another embodiment of the 3^{rd} conducting bracket of the present invention.

FIG. 16 is a function diagram of another embodiment of the 3^{rd} conducting bracket of the present invention.

### DETAILED DESCRIPTION OF THE PREFERRED EMBODIMENT

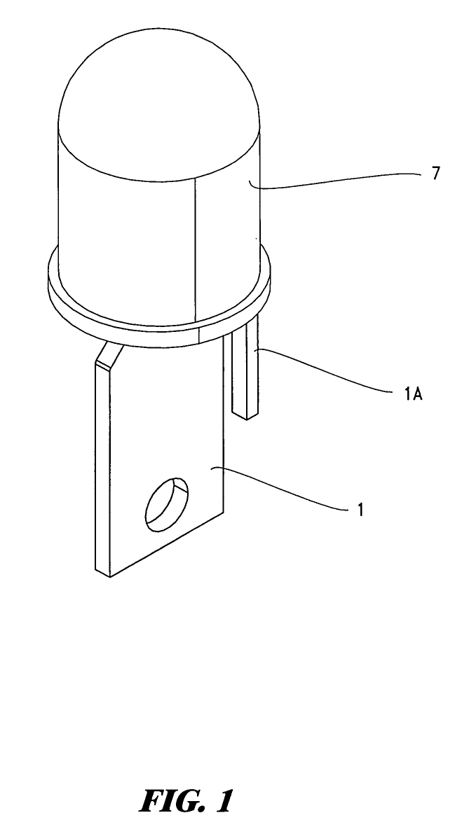

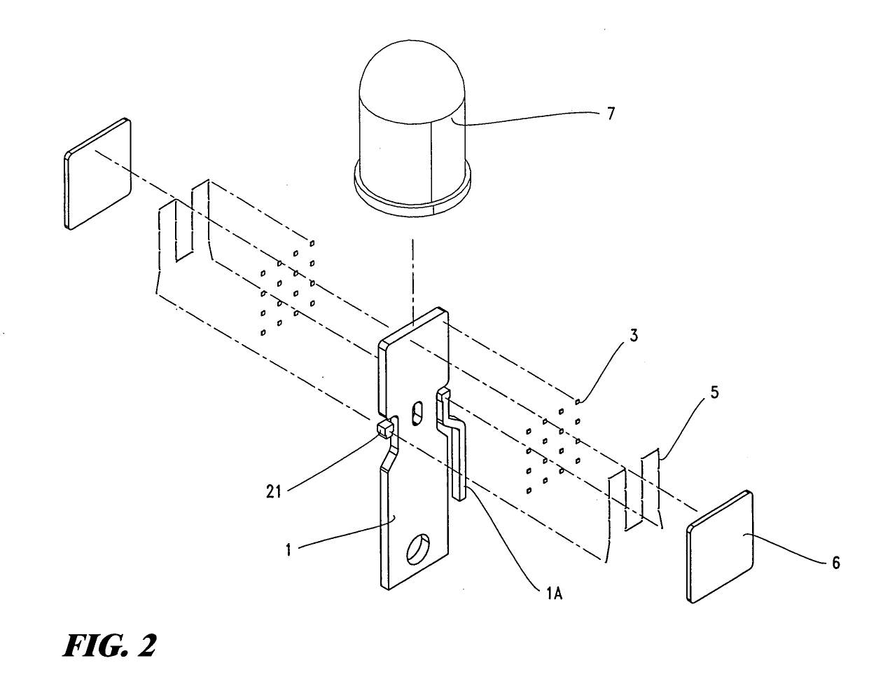

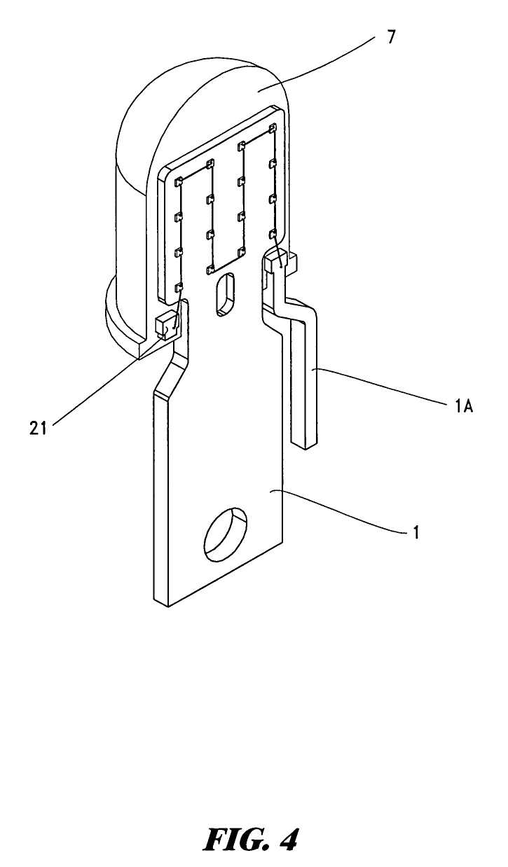

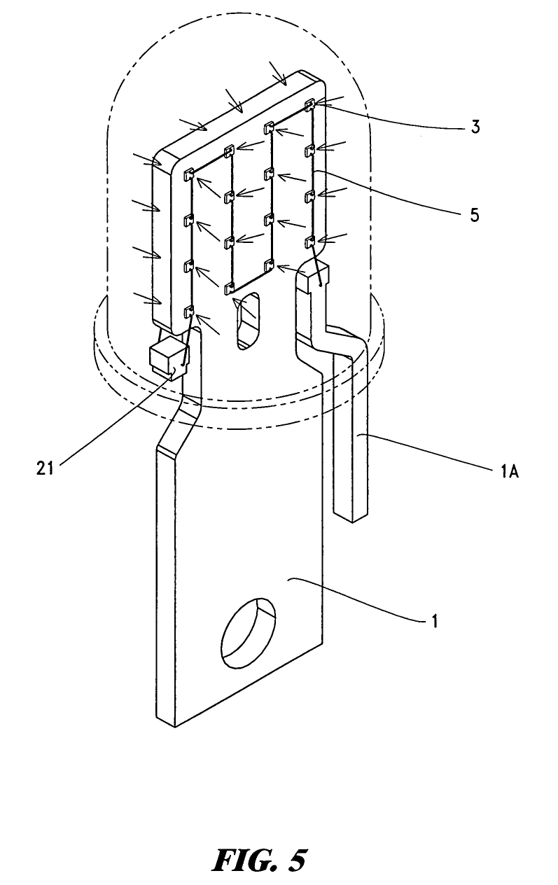

Please refer to FIGS. 1 through FIGS. 5. The present invention is related to a conducting bracket that can be bridged for expansion of multi-facet lighting chips, comprising the conducting bracket 1, 1A and 2, a plurality of chips 3, a plurality of conducting wires 5, a plurality of fluorescent layers 6 and sealing block 7; the conducting bracket 1 is mostly the rectangle body of the first conducting bracket; the conducting bracket 1A is the 2^{nd} conducting bracket arranged outside the main conducting bracket 1; the conducting bracket 2 is the 3^{rd} conducting bracket arranged on the other outer side of the main conducting bracket 1; the plurality of chips 3 are lighting semi-conductor chips for distribution and attaching above the conducting bracket 1; the plurality of conducting wires 5 are conducting material wires with its two ends available for connecting the chips 3 and the other end for serial connection of the conducting brackets 1A and 2; the plurality of fluorescent layers 6 are a surface of the chips covered with a fluorescent powder layer; the sealing block 7 is a resin or silicon injection made of transparent material sealing the conducting brackets 1, 1A and 2, the plurality of chips 3, the plurality of conducting wires 5 and a plurality of fluorescent layers 6.

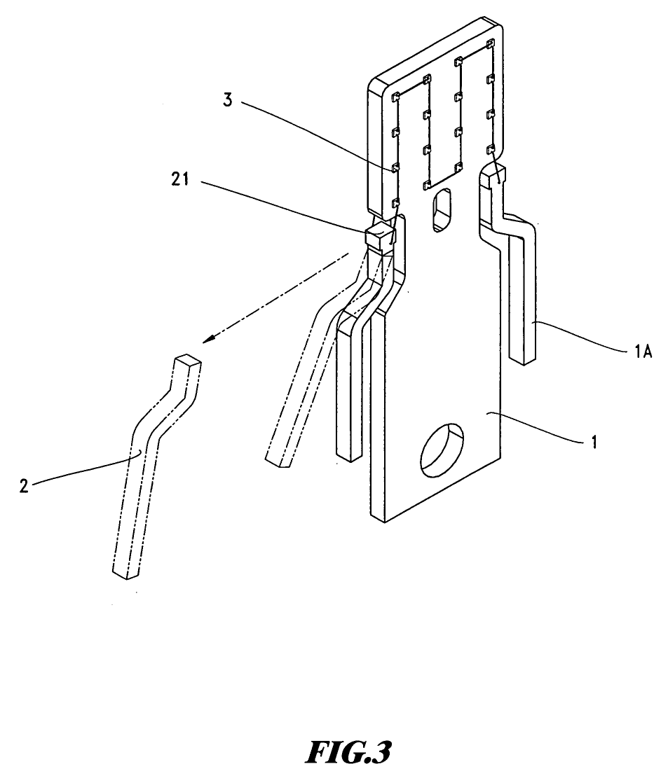

Please refer to FIGS. 3 through FIGS. 5 for the embodiment of the present invention. Mostly the first conducting bracket 1 is provided evenly with a plurality of chips 3 and the plurality of serially connected conducting wires 5 in an appropriate location before and after above, conducting bracket 1A on one side for connecting of the conducting wires 5 to the input electrode and the 3^{rd} conducting bracket 2 on the other side. The rectangle block 21 above the 3^{rd} conducting bracket 2 is provided to realize the bridging function of the other end of the conducting wires 5 of the chips of the blocks already serially connected at the front and back so as to achieve the serial connection and conducting effect of the chips of the blocks at the front and back. The rectangle block 21 is bridged, broken and sealed into the sealing block 7 so as to achieve the industrial application of a single LED bridged for expansion of multi-facet lighting sources.

In the embodiment of the present invention, the surface of the chips of the blocks is covered with a fluorescent layer 6 by design to allow the chips to provide the choice of color system effects of different light sources and double the light source selection change function.

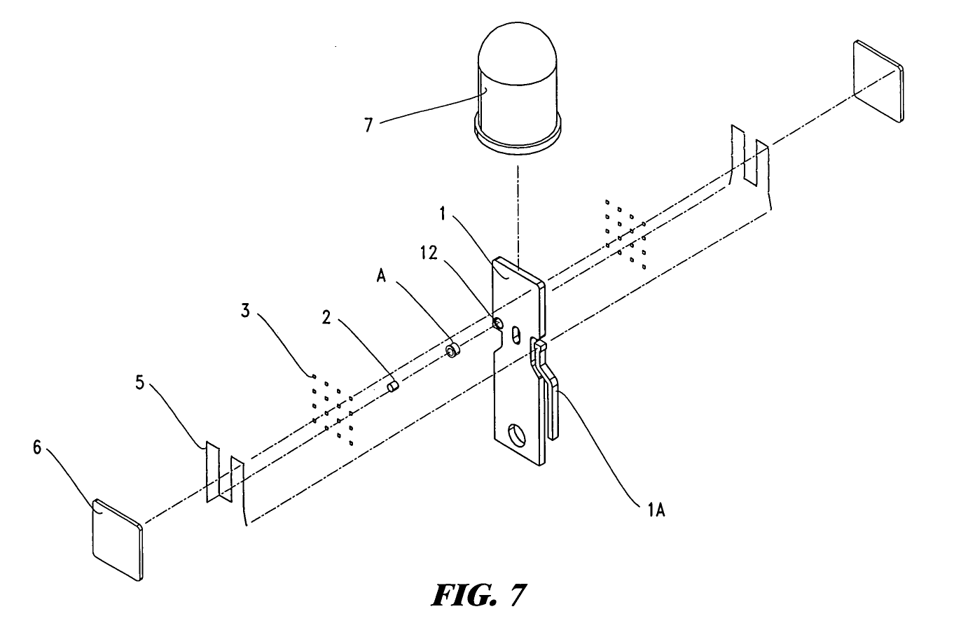

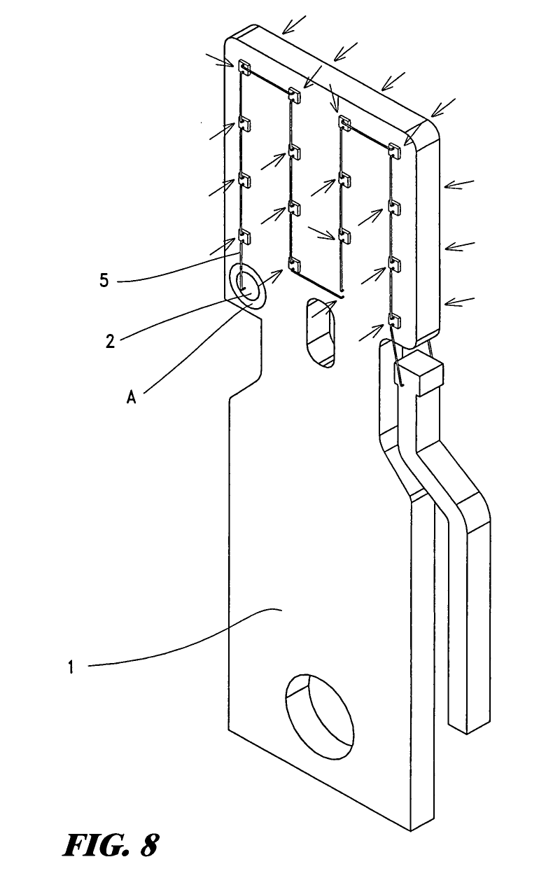

Please refer to FIG. 7 and FIG. 8 for another embodiment of the present invention. Another connecting hole 12 is arranged on the other side above the first conducting bracket 1 for insertion of the 3^{rd} conducting bracket 2 of corresponding shape and a insulated de-energizing layer A is arranged between the connecting hole and the 3^{rd} conducting bracket so that the 3^{rd} conducting bracket may provide the bridging function of the other end of the conducting wires 5 of the chips of the blocks already serially connected at the front and back and achieve the serial connection and conducting effect of the chips of the blocks at the front and back.

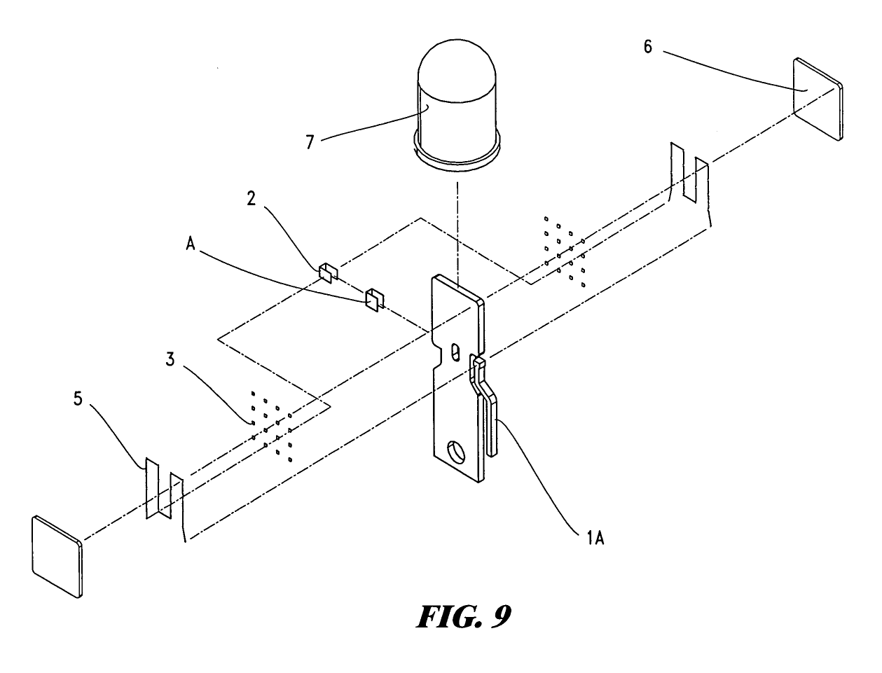

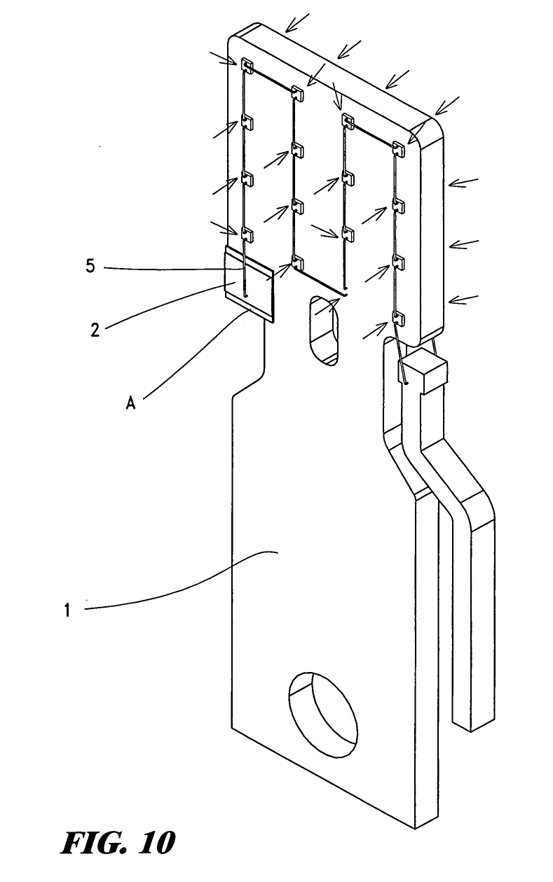

Please refer to FIG. 9 and FIG. 10 for another embodiment of the present invention. A C shaped 3^{rd} conducting bracket 2 is arranged above the first conducting bracket 1 and a relative C shaped insulated de-energizing layer A is arranged between the first conducting bracket and the 3^{rd} conducting bracket so that the 3^{rd} conducting bracket may provide the bridging function of the other end of the conducting wires 5 of the chips of the blocks already serially connected at the front and back and achieve the same serial connection and conducting effect of the chips of the blocks at the front and back.

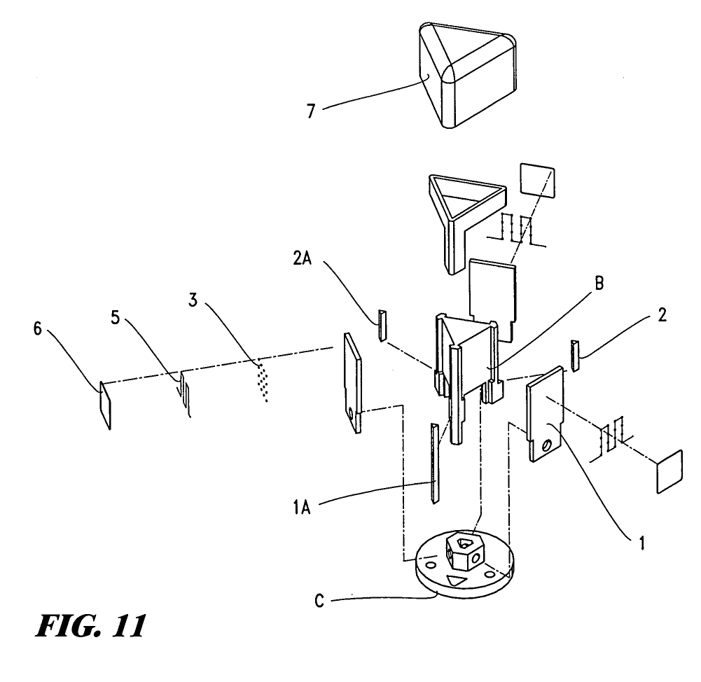

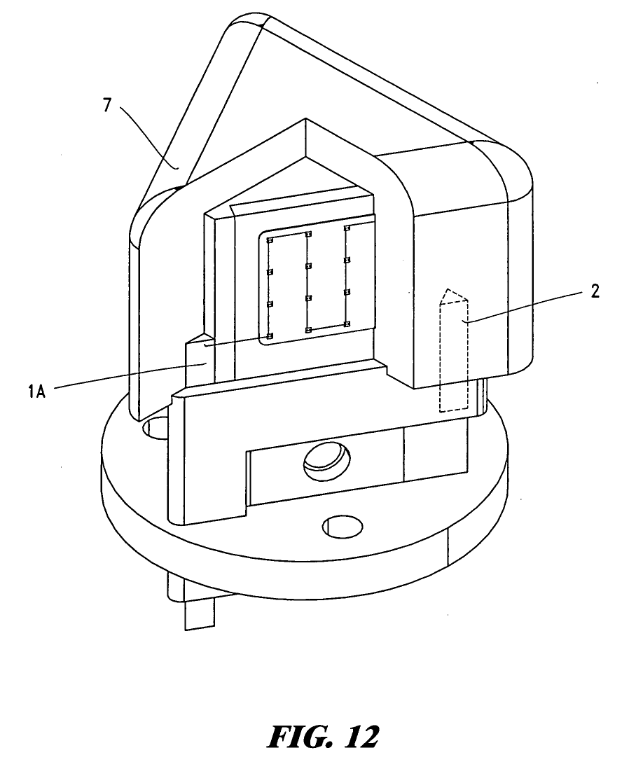

Please refer to FIG. 11 and FIG. 12 for another embodiment of the present invention. A triangle frame B and triangle base C are designed, and the 3 sets of first conducting brackets 1 may be combined to form a triangle bracket, the end points of the triangle bracket are provided for embedding the 2^{nd} conducting bracket 1A and the 3^{rd} conducting bracket 2 and 2A so that the 3^{rd} conducting bracket may provide the serial connection and 3-facet conducting & lighting effect of the chips of the bridged adjacent blocks.

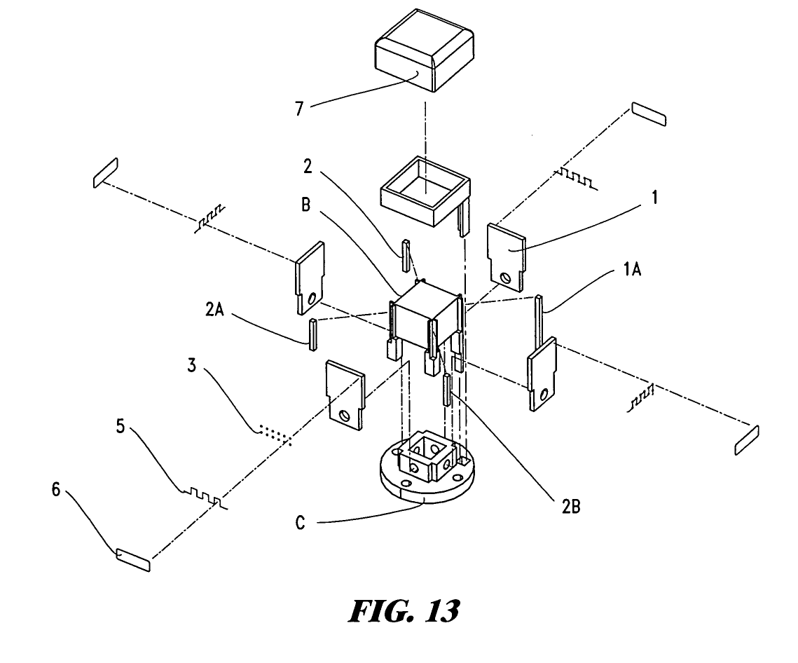

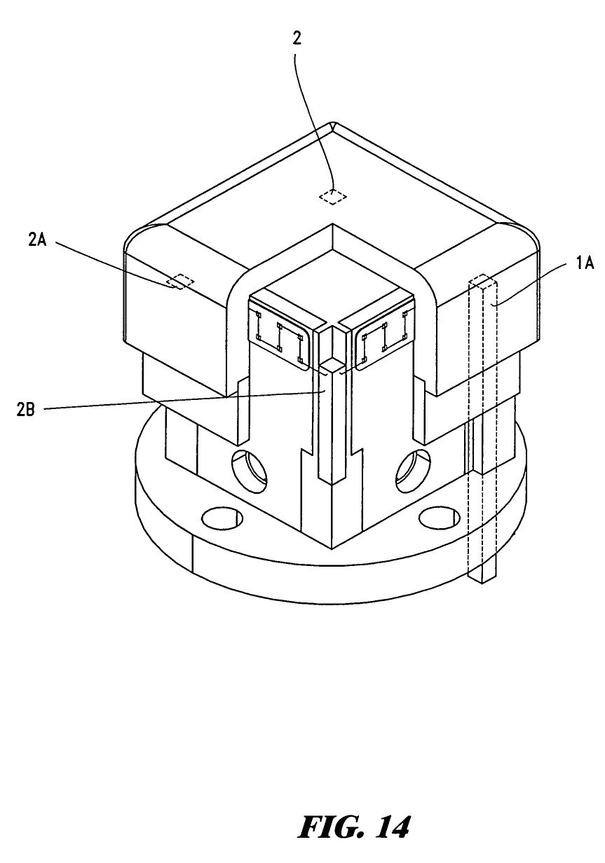

Refer to FIG. 13 and FIG. 14 for another embodiment of the present invention. A quadrangle frame B and quadrangle base C are designed and 4 sets of first conducting brackets 1 are combined to form a quadrangle bracket, and the end points of the quadrangle bracket are provided for embedding of the 2^{nd} conducting bracket 1A, 3^{rd} conducting brackets 2, 2A and 2B so that the 3^{rd} conducting bracket provides the serial connection and 4-facet conducting and lighting effect of the chips of the same adjacent blocks bridged.

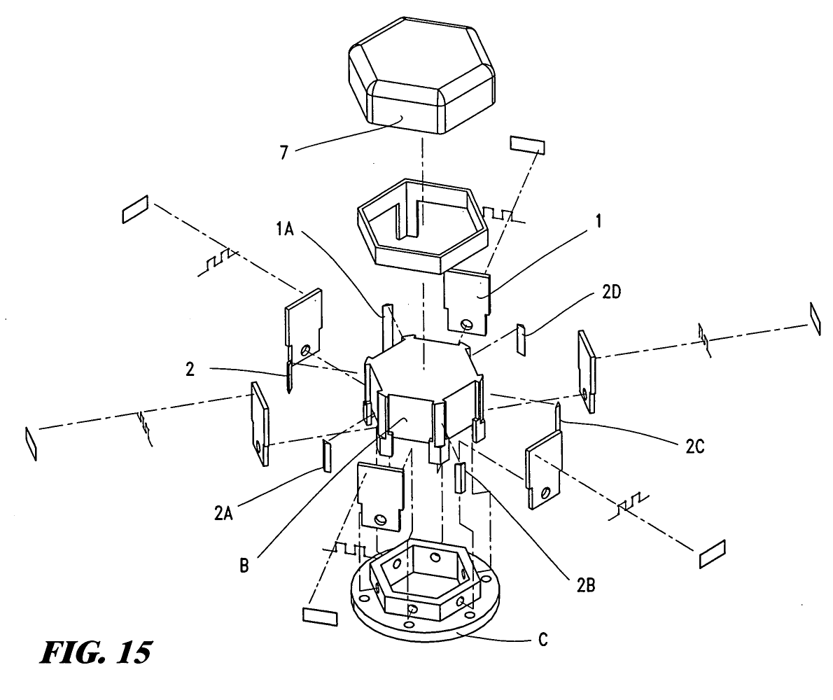

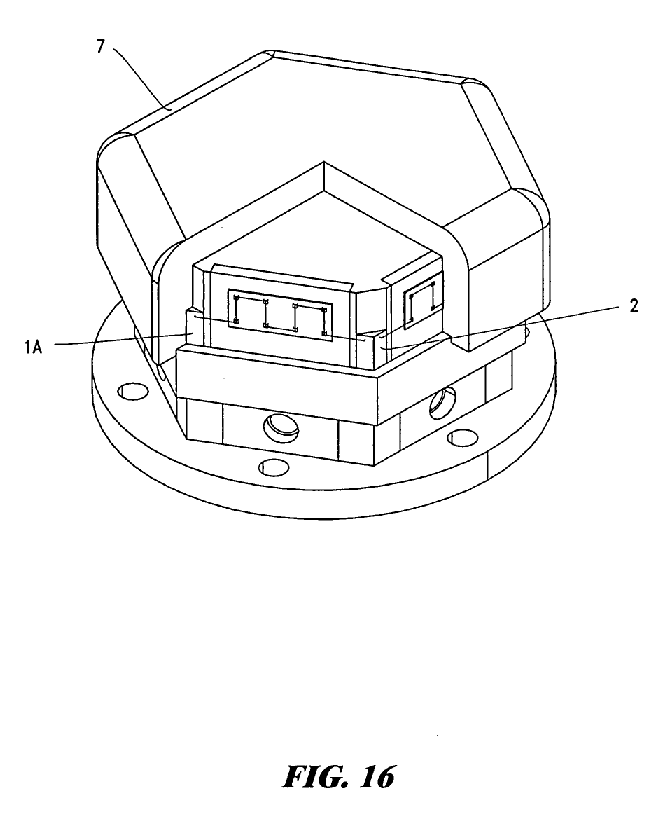

Refer to FIG. 15 and FIG. 16 for another embodiment of the present invention. A hexagon frame B and hexagon base C are designed and 6 sets of first conducting brackets 1 are combined to form a hexagon bracket, and the end points of the hexagon bracket are provided for embedding of the 2^{nd} conducting bracket 1A, 3^{rd} conducting brackets 2, 2A and 2B, 2C and 2D so that the 3^{rd} conducting bracket provides the serial connection and 6-facet conducting and lighting effect of the chips of the same adjacent blocks bridged.

I claim:

1. A conducting bracket that can be bridged for expansion of multi-facet lighting chips, comprising a plurality of conducting brackets, a plurality of chips, a plurality of conducting wires, a plurality of fluorescent layers and sealing blocks, the main improvements including: a plurality of conducting brackets, is the rectangle body of the first conducting bracket, the plurality of chips and attaching above, a 2^{nd} conducting bracket is provided on one side of the first conducting bracket, a first conducting bracket is provided on the other side 3^{rd} conducting bracket, wherein the rectangle block above the 3^{rd} conducting bracket may provide the bridging function of the conducting wires of the chips of the blocks already serially connected on the other end so as to achieve the serial connection and conducting effect of the chips of the blocks at the front and back and achieve the industrial application of a single LED bridged for expansion of multi-facet lighting sources.

2. The conducting bracket that can be bridged for expansion of multi-facet lighting chips according to claim 1, wherein the first conducting bracket and 3^{rd} conducting bracket may be expanded to combinations in which more than 3 facets are bridged.

3. The conducting bracket that can be bridged for expansion of multi-facet lighting chips according to claim 1, wherein the 3^{rd} conducting bracket may be C shaped clamping piece or round rod shaped insulation arranged on the other side of the first conducting bracket.
